(19) United States
(12) Patent Application Publication
(10) Pub. No.: US 2020/0144769 A1
(43) Pub. Date: May 7, 2020

(54) FITTING CONNECTOR

(71) Applicant: Yazaki Corporation, Tokyo (JP)

(72) Inventors: Yasuhiro Tanaka, Shizuoka (JP); Noboru Hayasaka, Shizuoka (JP); Shotaro Shibata, Shizuoka (JP)

(21) Appl. No.: 16/672,414

(22) Filed: Nov. 1, 2019

(30) Foreign Application Priority Data
Nov. 7, 2018 (JP) 2018-209599

(51) Int. Cl. H01R 13/639; H01R 13/627

(52) U.S. Cl. CPC H01R 13/639; H01R 13/6272

(57) ABSTRACT

A holding structure configured to hold connectors in a completely fitted state with a first lock holding portion and a second lock holding portion, and a secure member configured to secure the completely fitted state are provided. A lock holding body provided with the first lock holding portion includes a pressed movement portion configured to receive cancel force in a separation direction and move the first lock holding portion relative to the second lock holding portion in the separation direction. The secure member includes an operation portion configured to receive lock cancel operation when a lockable state of the first lock holding portion and the second lock holding portion is to be canceled.

### CROSS-REFERENCE TO RELATED APPLICATION(S)

The present application claims priority to and incorporates by reference the entire contents of Japanese Patent Application No. 2018-209599 filed in Japan on Nov. 7, 2018.

### BACKGROUND OF THE INVENTION

### 1. Field of the Invention

The present invention relates to a fitting connector.

### 2. Description of the Related Art

In a conventionally known fitting connector including two connectors such as a female connector and a male connector that are fitted to each other, terminals of both connectors are electrically connected with each other by completely fitting the connectors to each other. In such a fitting connector, a holding structure is provided between housings of the respective connectors to hold the fitted state of the connectors as the completely fitted state. The holding structure includes a first lock holding portion provided to one of the housings and a second lock holding portion provided to the other housing. The connectors are maintained in the completely fitted state by locking the first lock holding portion and the second lock holding portion to each other in a connector removal direction in the completely fitted state.

The holding structure has a lock cancel function to cancel the locked state of the first lock holding portion and the second lock holding portion. The lock cancel function is a function to separate the first lock holding portion and the second lock holding portion in the locked state from each other in response to a predetermined lock cancel operation. For example, the holding structure includes a lock holding body provided with the first lock holding portion, and the lock holding body has the lock cancel function. The lock holding body includes the first lock holding portion provided at one end, a lock cancel operation portion provided at the other end, a lock arm portion that is a cantilever provided with the first lock holding portion at a free end and disposed between the first lock holding portion and the lock cancel operation portion, and a pivot part configured to separate the first lock holding portion as the point of action from the second lock holding portion by elastically deforming the lock arm portion when the lock cancel operation portion as the point of effort in the locked state is moved by pressing. For example, Japanese Patent No. 5729248 discloses a fitting connector including such a holding structure.

In the conventional holding structure, the lock holding body has the function of locking to the second lock holding portion and the function of canceling the lock to the second lock holding portion, which results in increase in the size of the lock holding body. The increase in the size of the lock holding body potentially makes it difficult to reduce the entire size of the conventional fitting connector.

### SUMMARY OF THE INVENTION

Thus, it is an object of the present invention to provide a fitting connector that allows size reduction.

To achieve the objection, a fitting connector according to one aspect of the present invention includes a first connector that includes a terminal and a housing holding the terminal; a second connector that includes a counterpart terminal and a counterpart housing holding the counterpart terminal and is configured to electrically connect the terminal and the counterpart terminal when a fitted state of the housing and the counterpart housing upon insertion fitting is a completely fitted state; a holding structure that includes a first lock holding portion provided to the housing and a second lock holding portion provided to the counterpart housing and is configured to cause the first lock holding portion and the second lock holding portion to be in a lockable state in a connector removal direction to hold the fitted state as the completely fitted state when the fitted state is the completely fitted state; and a secure member configured to secure, when the fitted state is the completely fitted state, that the fitted state is the completely fitted state by regulating motion of the first lock holding portion relative to the second lock holding portion in a separation direction, wherein the housing includes a lock holding body including the first lock holding portion and a pressed movement portion configured to move the first lock holding portion relative to the second lock holding portion in the separation direction while receiving cancel force in the separation direction, and the secure member includes a position regulation portion configured to regulate motion of the first lock holding portion relative to the second lock holding portion in the separation direction when the fitted state is the completely fitted state, an operation portion configured to receive lock cancel operation when the lockable state of the first lock holding portion and the second lock holding portion is to be canceled, and a pressing movement portion configured to apply the cancel force in the separation direction on the pressed movement portion to separate the first lock holding portion from the second lock holding portion along with the lock cancel operation on the operation portion.

According to another aspect of the present invention, in the fitting connector, it is preferable that the secure member is assembled to the housing so that, when the fitted state is the completely fitted state, the secure member is relatively movable between a final lock position at which the position regulation portion regulates motion of the first lock holding portion relative to the second lock holding portion in the separation direction and a temporary lock position at which the position regulation portion does not regulate motion of the first lock holding portion relative to the second lock holding portion in the separation direction, and the pressing movement portion is formed not to apply the cancel force in the separation direction on the pressed movement portion when the secure member is at the final lock position but to apply the cancel force in the separation direction on the pressed movement portion when the secure member is at the temporary lock position.

According to still another aspect of the present invention, in the fitting connector, it is preferable that the pressing movement portion is formed so that the pressed movement portion is not disposed on a side in the separation direction relative to the pressing movement portion when the secure member is at the final lock position, but the pressed movement portion is oppositely disposed on the side in the separation direction relative to the pressing movement portion when the secure member is at the temporary lock position.

According to still another aspect of the present invention, in the fitting connector, it is preferable that the housing includes an operation allowance part configured to allow, when the secure member is at the temporary lock position, the lock cancel operation on the operation portion so that the pressing movement portion applies the cancel force in the separation direction on the pressed movement portion, and an operation regulation part configured to regulate, when the secure member is at the final lock position, the lock cancel operation on the operation portion so that the pressing movement portion does not apply the cancel force in the separation direction on the pressed movement portion.

According to still another aspect of the present invention, in the fitting connector, it is preferable that the secure member includes a guided portion that is guided when the secure member is moved relative to the housing, and the housing includes a guiding portion that guides the guided portion when the secure member is relatively moved, and a wall surface of the guiding portion opposite to the guided portion is used as the operation regulation part.

According to still another aspect of the present invention, in the fitting connector, it is preferable that the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

According to still another aspect of the present invention, in the fitting connector, it is preferable that the lock holding body uses, as the pressed movement portion, a wall part of the lock arm portion on a side opposite to the separation direction.

According to still another aspect of the present invention, in the fitting connector, it is preferable that the secure member includes a lock cancel arm portion connecting the operation portion and the pressing movement portion so that motion of the pressing movement portion in the separation direction occurs along with the lock cancel operation on the operation portion, and the lock cancel arm portion includes a pivot part configured to contact an outer wall surface of the housing and serve as a pivot to allow seesaw operation between the operation portion and the pressing movement portion of the secure member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a fitting connector when a secure member is at a final lock position;

FIG. 2 is a plan view illustrating the fitting connector when the secure member is at the final lock position;

FIG. 3 is a cross-sectional view taken along line X1-X1 in FIG. 2 and a partially enlarged diagram of the vicinity of a holding structure and the secure member;

FIG. 4 is a perspective view illustrating a state of a first connector and a second connector before fitting;

FIG. 5 is an exploded perspective view of the first connector;

FIG. 6 is an exploded perspective view of internal components of the first connector;

FIG. 7 is an exploded perspective view of the second connector;

FIG. 8 is a perspective view illustrating the fitting connector when the secure member is at a temporary lock position and a partially enlarged diagram of the vicinity of the holding structure and the secure member;

FIG. 9 is a plan view illustrating the fitting connector when the secure member is at the temporary lock position;

FIG. 10 is a cross-sectional view taken along line X2-X2 in FIG. 2 and a partially enlarged diagram of the vicinity of the holding structure and the secure member;

FIG. 11 is a cross-sectional view taken along line X2-X2 in FIG. 9 and a partially enlarged diagram of the vicinity of the holding structure and the secure member; and

FIG. 12 is a perspective view illustrating the fitting connector when the secure member is at the temporary lock position and a partially enlarged diagram of the vicinity of the holding structure and the secure member.

### DETAILED DESCRIPTION OF THE PREFERRED EMBODIMENTS

An embodiment of a fitting connector according to the present invention will be described below in detail with reference to the accompanying drawings. The present invention is not limited to the present embodiment.

### EMBODIMENT

The fitting connector is provided with two connectors (a first connector and a second connector) fitted to each other along with mutual insertion operation. In the fitting connector, terminals of both connectors are fitted to each other along with the insertion fitting operation and physically and electrically connected with each other. In addition, in the fitting connector, the connectors are separated from each other along with mutual removal operation, and accordingly, the physical and electrical connection between both terminals is canceled. The insertion direction and the removal direction are opposite to each other. Hereinafter, the insertion direction (fitting direction) toward each counterpart is referred to as a “connector insertion direction”, and the removal direction from the counterpart is referred to as a “connector removal direction”. When not distinguished from each other, these two directions are referred to as a “connector insertion-removal direction”. In addition, a direction orthogonal to the connector insertion-removal direction is referred to as a “first orthogonal direction”, and a direction orthogonal to the connector insertion-removal direction and the first orthogonal direction is referred to as a “second orthogonal direction”.

The fitted state of the connectors is roughly classified into a completely fitted state and a halfway fitted state. The completely fitted state refers to a state in which the housings of the connectors are completely inserted into each other to designed positions and physical and electrical connection holds between both terminals. The halfway fitted state refers to a state in which the housings of the connectors are fitted to each other but not in the completely fitted state. For example, the halfway fitted state refers to a fitted state before the completely fitted state is achieved during insertion fitting operation of the connectors, or the halfway fitted state refers to a fitted state after the completely fitted state is canceled during removal operation of the connectors.

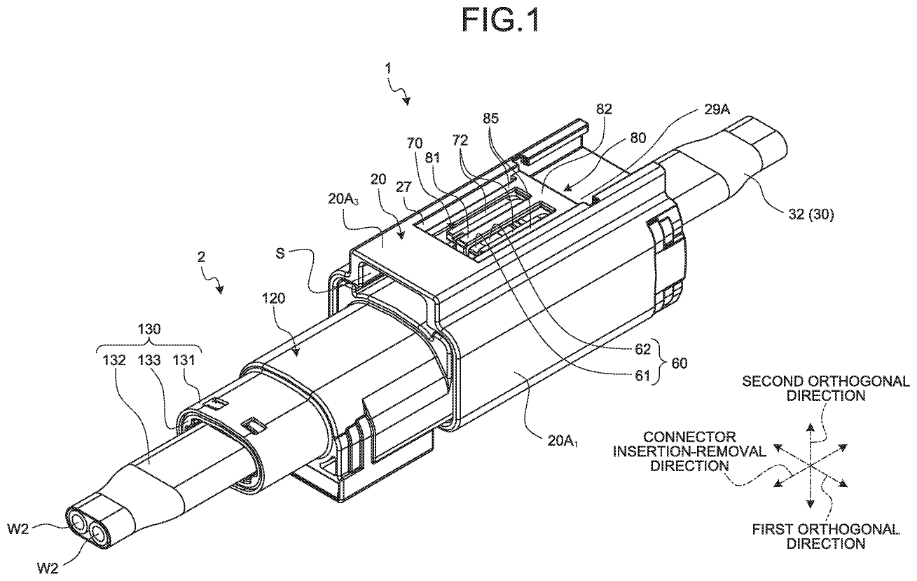

The following describes the fitting connector according to the present embodiment based on FIGS. 1 to 12.

Reference signs 1 and 2 in FIGS. 1 to 4 denote the first connector and the second connector, respectively, included in the fitting connector according to the present embodiment. The fitting connector according to the present embodiment is a female-male connector including a female connector and a male connector. In the following description, the first connector 1 is the female connector, and the second connector 2 is the male connector.

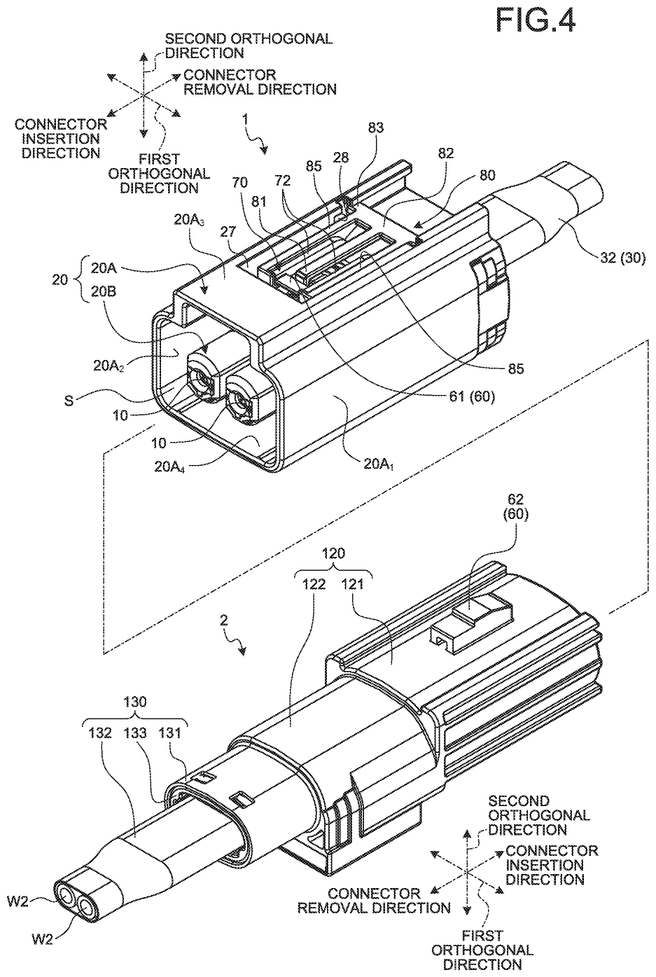

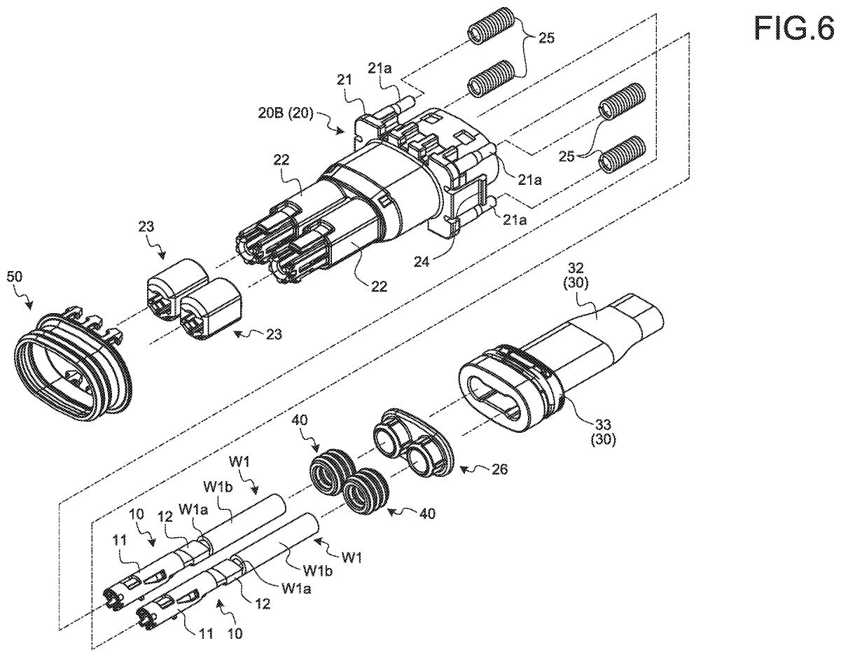

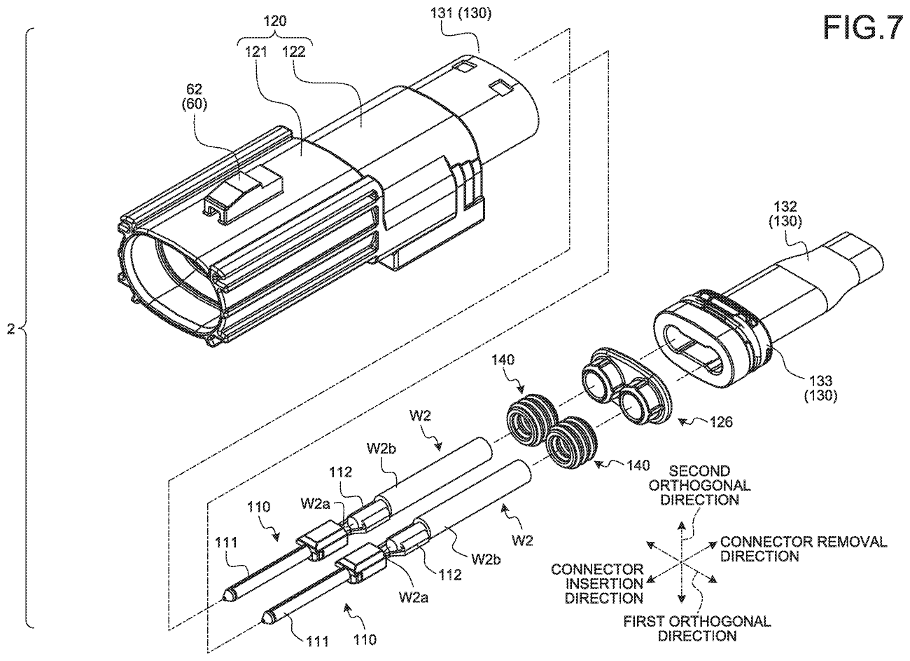

The first connector 1 includes a terminal (hereinafter referred to as a “female terminal”) 10, and a housing (hereinafter referred to as a “female housing”) 20 holding the female terminal 10 (FIGS. 4 to 6). The first connector 1 also includes a sealed structural body 30 (FIGS. 1 to 6) configured to prevent entering of noise from the outside, and a sealing member 40 (FIG. 6) configured to prevent ingress of liquid from the outside. The second connector 2 is a counterpart connector to be fitted to the first connector 1, and includes a counterpart terminal (hereinafter referred to as a “male terminal”) 110, a counterpart housing (hereinafter referred to as a “male housing”) 120 holding the male terminal 110, a sealed structural body 130 configured to prevent entering of noise from the outside, and a sealing member 140 configured to prevent ingress of liquid from the outside (FIG. 7). In the fitting connector, the female terminal 10 and the male terminal 110 are electrically connected with each other when the state of fitting therebetween along with insertion fitting between the female housing 20 and the male housing 120 is the completely fitted state. In this example, the male housing 120 is inserted toward inside of the female housing 20. In this example, two pairs of the female terminal 10 and the male terminal 110 to be physically and electrically connected with each other are provided. In the first connector 1, the two female terminals 10 are disposed side by side at an interval from each other in the direction (in this example, the first orthogonal direction) orthogonal to the connector insertion-removal direction.

In the second connector, the two male terminals 110 are disposed side by side at an interval from each other in the direction (in this example, the first orthogonal direction) orthogonal to the connector insertion-removal direction.

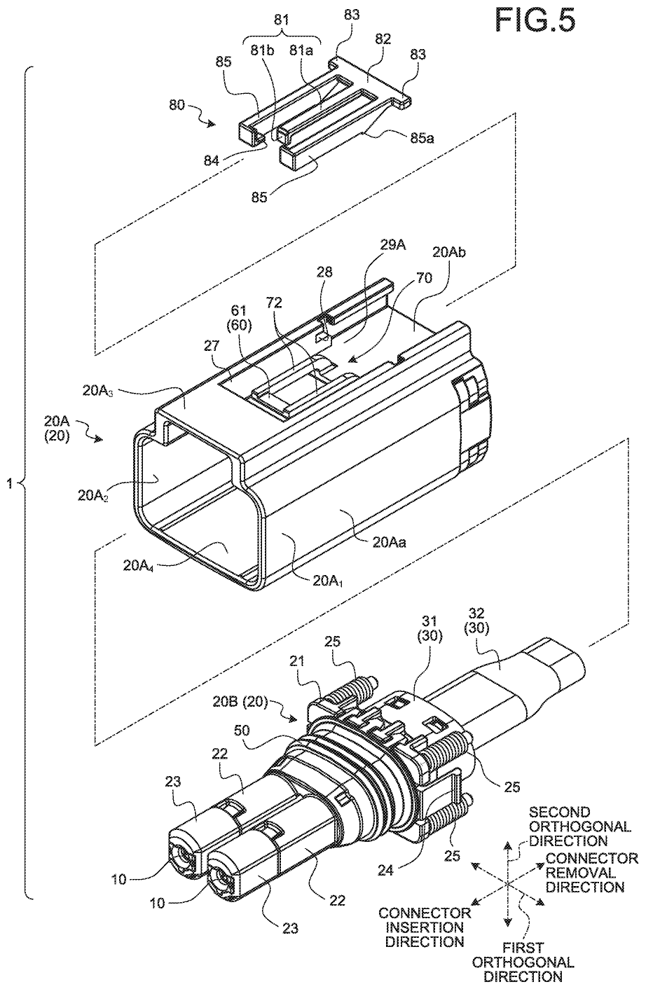

In addition, the fitting connector is provided with a sealing member 50 to improve liquid tightness at a fitting part between the first connector 1 and the second connector 2 (FIGS. 5 and 6). In this example, the sealing member 50 is provided to the first connector 1. In addition, the fitting connector is provided with a holding structure 60 configured to hold the state of fitting between the female housing 20 and the male housing 120 (hereinafter also referred to as “between the housings”) as the completely fitted state between the first connector 1 and the second connector 2 (FIGS. 1 to 5 and 7).

The female terminal 10 includes a terminal connection portion 11 configured to be physically and electrically connected with the male terminal 110, and an electrical line connection portion 12 configured to be physically and electrically connected with an electrical line W1 (FIG. 6). Similarly to the female terminal 10, the male terminal 110 includes a terminal connection portion 111 configured to be physically and electrically connected with the female terminal 10, and an electrical line connection portion 112 configured to be physically and electrically connected with an electrical line W2 (FIG. 7). In this example, the terminal connection portion 111 of the male terminal 110 is formed in a column shape having an axis line direction aligned with the connector insertion-removal direction, and the terminal connection portion 11 of the female terminal 10 is formed in a cylindrical shape in accordance with the shape of the terminal connection portion 111 to allow insertion fitting of the terminal connection portion 111 into the terminal connection portion 11. The electrical line connection portions 12 and 112 are formed to allow the electrical lines W1 and W2 to be extended in the connector removal direction. The electrical line connection portions 12 and 112 of this example are electrically connected with the core wires W1a and W2a through crimp press bonding to core wires W1a and W2a at terminals of the electrical lines W1 and W2.

The female housing 20 and the male housing 120 are made of insulating material such as synthesis resin material and each formed in a predetermined shape. The female housing 20 and the male housing 120 of this example each include a tubular hood having a tube axial direction aligned with the connector insertion-removal direction as described later in detail. Each hood uses its internal space as a terminal housing room, and a terminal holding body is disposed in an integrated state in the internal space. In the fitted state of the female housing 20 and the male housing 120, one of the hoods is housed inside the other hood. In this state, the tube axes of the hoods are substantially aligned with each other. In other words, in the fitting connector, the connector insertion-removal direction is along the tube axial directions of the hoods of the female housing 20 and the male housing 120.

Specifically, the female housing 20 has a two-division structure including an outer housing 20A and an inner housing 20B (FIGS. 4 and 5).

The outer housing 20A is a tubular housing having a tube axial direction aligned with the connector insertion-removal direction, and serves as the hood of the female housing 20 described above. The outer housing 20A has openings at both ends in the tube axial direction. The outer housing 20A of this example is formed in a rectangular tubular shape including first and second walls 20A₁ and 20A₂ having substantially rectangular shapes and oppositely disposed at an interval from each other in the first orthogonal direction, and third and fourth walls 20A₃ and 20A₄ having substantially rectangular shapes and oppositely disposed at an interval from each other in the second orthogonal direction (FIGS. 4 and 5). In the female housing 20, the inner housing 20B is housed and held in its internal space in a cube shape enclosed by the first to fourth walls 20A₁, 20A₂, 20A₃, and 20A₄. As described later, a secure member 80 is attached to the outer housing 20A.

The inner housing 20B includes a terminal housing portion 21 in which each female terminal 10 is housed, and a terminal holding portion 22 as the above-described terminal holding body for each female terminal 10 (FIGS. 5 and 6). The terminal housing portion 21 is formed in a tubular shape having a tube axial direction aligned with the connector insertion-removal direction and having openings at both ends, and the terminal housing room (not illustrated) for each female terminal 10 is formed inside the terminal housing portion 21. The terminal holding portion 22 is formed in a tubular shape having a tube axial direction aligned with the connector insertion-removal direction and having openings at both ends, and extends in the connector insertion direction from the opening at an end part of the terminal housing portion 21 on a side in the connector insertion direction. Two of the terminal holding portions 22 are disposed side by side for each female terminal 10. In this example, the terminal holding portions 22 are arranged in the first orthogonal direction.

The internal space of each terminal holding portion 22 serves as the terminal housing room (not illustrated), and each terminal housing room is communicated with the terminal housing room of the terminal housing portion 21 through the opening at the end part on the side in the connector removal direction.

The female terminal 10 together with the terminal of the electrical line W1 is inserted through the opening at the end part of the terminal housing portion 21 on the side in the connector removal direction, and housed in the terminal housing room of the terminal housing portion 21 and the terminal housing room of the terminal holding portion 22. The terminal housing room of the terminal housing portion 21 houses the electrical line connection portion 12 of the female terminal 10, and the terminal of the electrical line W1 connected with the electrical line connection portion 12. The terminal housing room of the terminal holding portion 22 houses and holds the terminal connection portion 11 of the female terminal 10. A lid member 23 in a tubular shape having openings at both ends is attached to the end part of the terminal holding portion 22 on the side in the connector insertion direction (FIGS. 5 and 6).

The electrical line W1 is extended to the outside through the opening of the terminal housing portion 21 at the end part on the side in the connector removal direction. Thus, the sealing member 40 concentric with the electrical line W1 and having an annular shape that allows insertion of the electrical line W1 is deployed in each terminal housing room of the terminal housing portion 21. The sealing member 40 prevents ingress of liquid (such as water) from the electrical line W1 side into the terminal holding portion 22 when a cover W1b (FIG. 6) of the electrical line W1 closely contacts the inner peripheral surface of the sealing member 40 and the inner peripheral surface of the terminal housing room of the terminal housing portion 21 closely contacts the outer peripheral surface of the sealing member 40.

The inner housing 20B is inserted into the internal space of the outer housing 20A through the opening of the outer housing 20A on the side in the connector insertion direction, and prevented from being separated from the opening by a lock mechanism 24 at the terminal housing portion 21 (FIGS. 5 and 6). The lock mechanism 24 is achieved by a lock portion such as a click portion provided to each of the inner peripheral surface of the outer housing 20A and the terminal housing portion 21, and regulates motion of the inner housing 20B relative to the outer housing 20A toward the side in the connector insertion direction. The lock mechanism 24 causes the click portion of the inner housing 20B to move over the click portion of the outer housing 20A along with insertion operation of the inner housing 20B into the internal space of the outer housing 20A, thereby disposing the click portions in a lockable state.

In the female housing 20, an elastic member 25 is interposed between the outer housing 20A and the inner housing 20B (FIGS. 5 and 6). The elastic member 25 is disposed at each of four corner parts of the outer housing 20A on the side in the connector removal direction between the terminal housing portion 21 and a wall surface partially blocking an opening at the corner part. Each elastic member 25 is disposed to apply snapping force therebetween in the connector insertion-removal direction. In this example, a helical spring is used as the elastic member 25, and a shaft 21a inserted into the elastic member 25 for pivotal support is provided at each of the four corners of the terminal housing portion 21 (FIG. 6). Each elastic member 25 is pressed and contracted when the click portion of the inner housing 20B has moved over the click portion of the outer housing 20A, and the lock portions of the lock mechanisms 24 are locked to each other by snapping force in the extension direction as reaction force of the elastic member 25.

The sealed structural body 30 prevents entering of noise from the outside into the female terminal 10 housed in the female housing 20 and the terminal of the electrical line W1. The sealed structural body 30 of this example includes a sealed shell 31, a braid 32, and a connection member 33 (FIGS. 5 and 6).

The sealed shell 31 is made of conductive material such as metal and formed in a tubular shape having a tube axial direction aligned with the connector insertion-removal direction and having openings at both ends. In the sealed shell 31, the terminal housing portion 21 of the inner housing 20B is disposed on the same tube axis, and the inner housing 20B is integrally shaped by insert molding or the like at the terminal housing portion 21.

The outer peripheral surface of the sealed shell 31 of this example at an end part on the side in the connector insertion direction is exposed after the inner housing 20B is formed. The exposed surface of the sealed shell 31 on the side in the connector insertion direction is physically and electrically connected with a sealed shell 131 of the second connector 2 after completion of fitting into the second connector 2.

The sealed shell 31 of this example protrudes from the end part of the terminal housing portion 21 on the side in the connector removal direction. In the sealed shell 31, the two electrical lines W1 are extended from an end part of the protruding part on the side in the connector removal direction. A holder (what is called rear holder) 26 holding the two electrical lines W1 is fitted inside the sealed shell 31 (FIG. 6). The holder 26 is made of insulating material such as synthesis resin. The outer peripheral surface of the protruding part of the sealed shell 31 together with the extended electrical lines W1 is covered by the braid 32. The braid 32 is a member made of conductive material such as metal and woven in a tubular and net shape. The connection member 33 is connected with the sealed shell 31 with the braid 32 interposed between the connection member 33 and the sealed shell 31. The connection member 33 of this example is fitted inside the sealed shell 31, and the braid 32 is pressed against the inner peripheral surface of the sealed shell 31, thereby holding the electrically connected state of the sealed shell 31 and the braid 32.

In the first connector 1 of this example, a tubular space S opened at an end part on the side in the connector insertion direction is formed between the outer housing 20A and each of the inner housing 20B and the sealed shell 31 on the side in the connector insertion direction relative to the exposed surface of the sealed shell 31 on the side in the connector insertion direction (FIGS. 1 and 4). The second connector 2 is fitted to the first connector 1 while being inserted into the tubular space S through the opening.

Accordingly, the side of the second connector 2 in the connector insertion direction is housed inside the outer housing 20A. Then, the end part of the terminal housing portion 21 on the side in the connector insertion direction, the end part of the sealed shell 31 on the side in the connector insertion direction, and the terminal holding portion 22 are inserted into the male housing 120 on the side of the second connector 2 in the connector insertion direction. Along with the insertion, the male terminal 110 is inserted into the terminal connection portion 11 through the opening of the terminal holding portion 22. To achieve this, the sealing member 50 is formed in an annular shape into which the end part of the terminal housing portion 21 on the side in the connector insertion direction is inserted. Then, the inner peripheral surface of the sealing member 50 closely contacts the end part of the terminal housing portion 21, and the outer peripheral surface of the sealing member 50 closely contacts the inner peripheral surface of the male housing 120 inserted into the space S. The opening of the terminal housing portion 21 at the end part on the side in the connector insertion direction is blocked except for a part communicated with the terminal holding portion 22.

The male housing 120 is a counterpart tubular housing having a tube axial direction aligned with the connector insertion-removal direction, and is inserted and fitted into the internal space of the female housing 20 (the tubular space S of the first connector 1). The male housing 120 includes a terminal housing portion 121 in which each male terminal 110 is housed, and a terminal holding portion 122 functioning as the above-described terminal holding body for each male terminal 110 (FIGS. 4 and 7). The terminal housing portion 121 is formed in a tubular shape having a tube axial direction aligned with the connector insertion-removal direction and having openings at both ends, and the terminal housing room (not illustrated) for each male terminal 110 is formed inside the terminal housing portion 121. An end part of the terminal housing portion 121 on the side in the connector insertion direction serves as the above-described hood and is inserted into the tubular space S of the first connector 1. The inner peripheral surface of this end part closely contacts the outer peripheral surface of the sealing member 50. The terminal housing portion 121 of this example is formed in a tubular shape in accordance with the shape of the outer peripheral surface of the terminal housing portion 21 of the inner housing 20B and the shape of the outer peripheral surface of the sealed shell 31. The terminal holding portion 122 is formed in a tubular shape having a tube axial direction aligned with the connector insertion-removal direction and having openings at both ends, and the terminal housing room (not illustrated) for each male terminal 110 is formed inside terminal holding portion 122. The terminal holding portion 122 is disposed in the opening of the terminal housing portion 121 at the end part on the side in the connector removal direction. The terminal housing room of the terminal holding portion 122 is communicated with the terminal housing room of the terminal housing portion 121 through the opening at the end part on the side in the connector insertion direction.

The male terminal 110 together with the terminal of the electrical line W2 is inserted through the opening of the terminal holding portion 122 at the end part on the side in the connector removal direction and housed in the terminal housing room of the terminal housing portion 121 and the terminal housing room of the terminal holding portion 122. The terminal connection portion 111 of the male terminal 110 is housed in the terminal housing room of the terminal housing portion 121. The electrical line connection portion 112 of the male terminal 110 and the terminal of the electrical line W2 connected with the electrical line connection portion 112 are housed in the terminal housing room of the terminal holding portion 122.

The electrical line W2 is extended to the outside through the opening of the terminal holding portion 122 at the end part on the side in the connector removal direction. To achieve this, the sealing member 140 concentric with the electrical line W2 and having an annular shape that allows insertion of the electrical line W2 is deployed in each terminal housing room of the terminal holding portion 122 (FIG. 7). The inner peripheral surface of the sealing member 140 closely contacts a cover W2b of the electrical line W2, and the outer peripheral surface of the sealing member 140 closely contacts the inner peripheral surface of the terminal housing room of the terminal holding portion 122, thereby preventing ingress of liquid (such as water) from the electrical line W2 side into the terminal housing portion 121.

The sealed structural body 130 prevents entering of noise from the outside into the male terminal 110 and the terminal of the electrical line W2 housed in the male housing 120. The sealed structural body 130 of this example includes the sealed shell 131, a braid 132, and a connection member 133 (FIGS. 4 and 7).

The sealed shell 131 is made of conductive material such as metal and has a tubular shape having a tube axial direction aligned with the connector insertion-removal direction and having openings at both ends. The sealed shell 131 is disposed across the terminal housing portion 121 and the terminal holding portion 122 of the male housing 120, and the male housing 120 is integrally shaped by insert molding or the like.

The inner peripheral surface of the sealed shell 131 of this example at an end part on the side in the connector insertion direction is exposed after the male housing 120 is formed. The exposed surface of the sealed shell 131 on the side in the connector insertion direction is physically and electrically connected with the sealed shell 31 of the first connector 1 after completion of fitting into the first connector 1.

The sealed shell 131 of this example protrudes from the end part of the male housing 120 on the side in the connector removal direction. In the sealed shell 131, the two electrical lines W2 are extended from an end part of the protruding part on the side in the connector removal direction. A holder (what is called rear holder) 126 holding the two electrical lines W2 is fitted inside the sealed shell 131 (FIG. 7). The holder 126 is made of insulating material such as synthesis resin. The outer peripheral surface of the protruding part of the sealed shell 131 together with the extended electrical lines W2 is covered by the braid 132. The braid 132 is a member made of conductive material such as metal and woven in a tubular and net shape. The connection member 133 is connected with the sealed shell 131 with the braid 132 interposed between the connection member 133 and the sealed shell 131. The connection member 133 of this example is fitted inside the sealed shell 131, and the braid 132 is pressed against the inner peripheral surface of the sealed shell 131, thereby holding the electrically connected state of the sealed shell 131 and the braid 132.

In the fitting connector, when the fitted state of the female housing 20 and the male housing 120 is the completely fitted state, the holding structure 60 regulates relative movement between the housings in the connector removal direction to hold the female housing 20 and the male housing 120 in the completely fitted state. The holding structure 60 includes a first lock holding portion 61 provided to the female housing 20, and a second lock holding portion 62 provided to the male housing 120 (FIGS. 1 to 4). When the fitted state of the female housing 20 and the male housing 120 is the completely fitted state, the holding structure 60 causes the first lock holding portion 61 and the second lock holding portion 62 to be in the lockable state in the connector removal direction to hold the fitted state as the completely fitted state.

The holding structure 60 includes a lock holding body 70 provided with the first lock holding portion 61 (FIGS. 1 to 5). The lock holding body 70 is provided to the female housing 20. In this example, the lock holding body 70 is formed integrally with the outer housing 20A.

The lock holding body 70 is provided with the first lock holding portion 61 at one end in the connector insertion-removal direction (FIGS. 1 to 5). The lock holding body 70 of this example is provided with the first lock holding portion 61 at an end part on the side in the connector insertion direction at the outer housing 20A.

The lock holding body 70 also includes a lock arm portion 72 that is an elastically deformable cantilever provided with the first lock holding portion 61 at a free end and provided with a fixed end on the side in the connector removal direction relative to the first lock holding portion 61 (FIGS. 1 to 5). The lock arm portion 72 extends in the connector insertion-removal direction. The fixed end of the lock arm portion 72 is connected with the outer wall surface of the outer housing 20A. The lock holding body 70 is connected with the outer wall surface of the outer housing 20A in a cantilever state through the fixed end of the lock arm portion 72.

The lock holding body 70 of this example includes two of the lock arm portions 72 disposed at an interval from each other in the first orthogonal direction, and uses, as the first lock holding portion 61, a piece having a rectangular flat plate shape and connecting the free ends of the lock arm portions 72 (FIGS. 1 to 5).

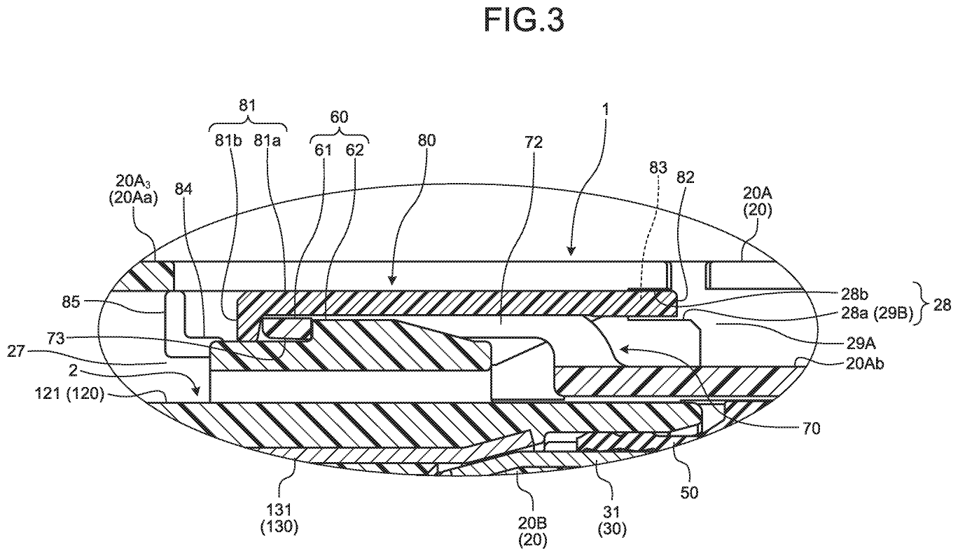

The second lock holding portion 62 is formed as a protrusion portion that is inserted into a space surrounded by the first lock holding portion 61 and the two lock arm portions 72 of the lock holding body 70 and is disposed opposite to the first lock holding portion 61 in the connector removal direction when the fitted state of the housings is the completely fitted state. In the holding structure 60, the second lock holding portion 62 protrudes from the outer wall surface of the terminal housing portion 121 of the male housing 120 (FIGS. 4, 3, and 7).

In this example, a through-hole 27 is provided to the outer peripheral wall of the outer housing 20A (FIGS. 1, 3, 4, and 5). The space of the lock holding body 70 into which the second lock holding portion 62 is inserted is disposed opposite to at least the through-hole 27. The second lock holding portion 62 provided to the outer wall surface of the male housing 120 is oppositely disposed in the through-hole 27 when the fitted state of the housings is the completely fitted state.

Specifically, the outer housing 20A of this example includes, as the outer wall surface, a main outer wall surface 20Aa serving as an outline shape, and a sub outer wall surface 20Ab offset on the internal space side of the main outer wall surface 20Aa (FIGS. 3 and 5).

The lock holding body 70 is disposed on the internal space side of the main outer wall surface 20Aa with the fixed end of the lock arm portion 72 connected with the sub outer wall surface 20Ab. The through-hole 27 described above is formed on the side in the connector insertion direction relative to the sub outer wall surface 20Ab. Accordingly, the lock holding body 70 of this example is disposed in the through-hole 27 except for the fixed end of the lock arm portion 72 and oppositely disposed at an interval to the outer wall surface of the terminal housing portion 121.

In the fitting connector, as the insertion fitting operation between the housings proceeds, the first lock holding portion 61 is mounted on the second lock holding portion 62 along with elastic deformation of the lock arm portion 72. Then, in the fitting connector, as the fitted state of the housings becomes the completely fitted state, the first lock holding portion 61 moves over the second lock holding portion 62, and the first lock holding portion 61 and the second lock holding portion 62 are oppositely disposed in the connector removal direction along with cancellation of the elastic deformation of the lock arm portion 72 (FIGS. 1 and 3). Accordingly, in the holding structure 60, the first lock holding portion 61 and the second lock holding portion 62 become the lockable state.

In the fitting connector of this example, when the first connector 1 and the second connector 2 are inserted and fitted in each other, each elastic member 25 described above is pressed and contracted by pressing force from the second connector 2 side to the inner housing 20B. Then, in the fitting connector, as the fitted state of the housings becomes the completely fitted state, the male housing 120 is pressed back through the inner housing 20B by snapping force of each elastic member 25 in the extension direction, and the first lock holding portion 61 and the second lock holding portion 62 are locked to each other. In other words, when the fitted state of the housings is the completely fitted state, each elastic member 25 of the first connector 1 applies the snapping force in the connector removal direction on the first connector 1 and the second connector 2 to cause, with the snapping force, the first lock holding portion 61 and the second lock holding portion 62 to be in a locked state in the connector removal direction, thereby holding the fitted state as the completely fitted state.

In the holding structure 60, when the lockable state or the locked state of the first lock holding portion 61 and the second lock holding portion 62 is to be canceled, the first lock holding portion 61 is lifted up and separated from the second lock holding portion 62 in the second orthogonal direction to cancel the oppositely disposed state of the first lock holding portion 61 and the second lock holding portion 62 in the connector removal direction. In other words, in the fitting connector, the completely fitted state of the first connector 1 and the second connector 2 achieved by the holding structure 60 can be ensured by regulating motion of the first lock holding portion 61 relative to the second lock holding portion 62 in the separation direction.

The fitting connector is provided with the secure member 80 configured to secure, when the fitted state of the housings is the completely fitted state, that the fitted state is the completely fitted state by regulating motion of the first lock holding portion 61 relative to the second lock holding portion 62 in the separation direction (FIGS. 1 to 5). The secure member 80 secures that the fitted state is the completely fitted state by regulating motion of the first lock holding portion 61 in the separation direction to maintain the lockable state of the first lock holding portion 61 and the second lock holding portion 62.

The secure member 80 is capable of moving relative to the female housing 20 in the connector insertion-removal direction. The secure member 80 is assembled to the female housing 20 so that, when the fitted state of the housings is the completely fitted state, the secure member 80 is movable relative to the female housing 20 between a final lock position and a temporary lock position in the connector insertion-removal direction. The secure member 80 is also assembled to the female housing 20 so that the position of the secure member 80 relative to the female housing 20 is the temporary lock position until the fitted state of the housings becomes the completely fitted state. The secure member 80 of this example is assembled to the outer housing 20A so that the secure member 80 is movable relative to the outer housing 20A in the connector insertion-removal direction.

The final lock position refers to the position of the secure member 80 relative to the female housing 20 at which a position regulation portion 81 described below regulates motion of the first lock holding portion 61 relative to the second lock holding portion 62 in the separation direction. The secure member 80 at the final lock position regulates motion of the first lock holding portion 61 relative to the second lock holding portion 62 in the separation direction by locking any site of the lock holding body 70. The secure member 80 of this example regulates motion of the first lock holding portion 61 relative to the second lock holding portion 62 in the separation direction by locking the first lock holding portion 61 at the final lock position. The temporary lock position refers to the position of the secure member 80 relative to the female housing 20 at which the position regulation portion 81 does not regulate motion in the separation direction. The secure member 80 of this example at the temporary lock position cannot lock the first lock holding portion 61 and cannot regulate motion of the first lock holding portion 61 relative to the second lock holding portion 62 in the separation direction.

The secure member 80 is assembled to the outer housing 20A of the female housing 20. The secure member 80 includes the position regulation portion 81 configured to regulate motion of the first lock holding portion 61 relative to the second lock holding portion 62 in the separation direction when the fitted state of the housings is the completely fitted state, and an operation portion 82 configured to receive operation to move the secure member 80 relative to the female housing 20 in the connector insertion-removal direction (FIGS. 1 to 5). In the secure member 80 of this example, the operation portion 82 is disposed on the side in the connector removal direction relative to the position regulation portion 81.

Specifically, the position regulation portion 81 is formed to regulate motion of the first lock holding portion 61 relative to the second lock holding portion 62 in the separation direction when the fitted state of the housings is the completely fitted state and the position of the secure member 80 relative to the female housing 20 is the final lock position. Thus, the position regulation portion 81 is formed so that, in the completely fitted state, the position regulation portion 81 is disposed on the separation direction side of the first lock holding portion 61 relative to the first lock holding portion 61 and the second lock holding portion 62 in the lockable state or the locked state. The position regulation portion 81 is also formed so that, when the fitted state of the housings is not the completely fitted state or when the fitted state is the completely fitted state but the secure member 80 is at the temporary lock position, the position regulation portion 81 is disposed on the side in the connector removal direction relative to the first lock holding portion 61.

The position regulation portion 81 of this example includes an arm part 81a that is an elastically deformable cantilever extending in the connector insertion-removal direction, and a protrusion portion 81b provided to a free end of the arm part 81a and protruding opposite to the separation direction of the first lock holding portion 61 relative to the second lock holding portion 62 (FIGS. 3 and 5). The arm part 81a has a free end at one end on the side in the connector insertion direction and a fixed end at the other end on the side in the connector removal direction. The fixed end of the arm part 81a is connected with the operation portion 82. The protrusion portion 81b is disposed on the side in the connector insertion direction relative to the first lock holding portion 61 when the fitted state of the housings is the completely fitted state and the position of the secure member 80 relative to the female housing 20 is the final lock position.

The operation portion 82 of this example is formed in a rectangular flat plate shape. The operation portion 82 is formed so that the plate thickness direction thereof is aligned with the second orthogonal direction. The operation portion 82 is disposed on the side in the connector removal direction relative to the lock holding body 70 irrespective of the position of the secure member 80 relative to the female housing 20. Thus, the operation portion 82 is oppositely disposed at an interval to the sub outer wall surface 20Ab in the second orthogonal direction.

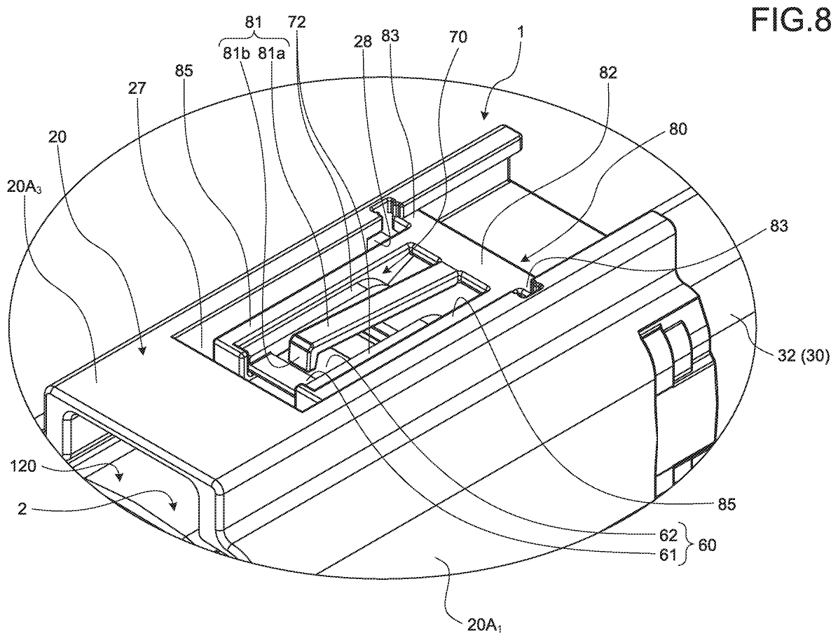

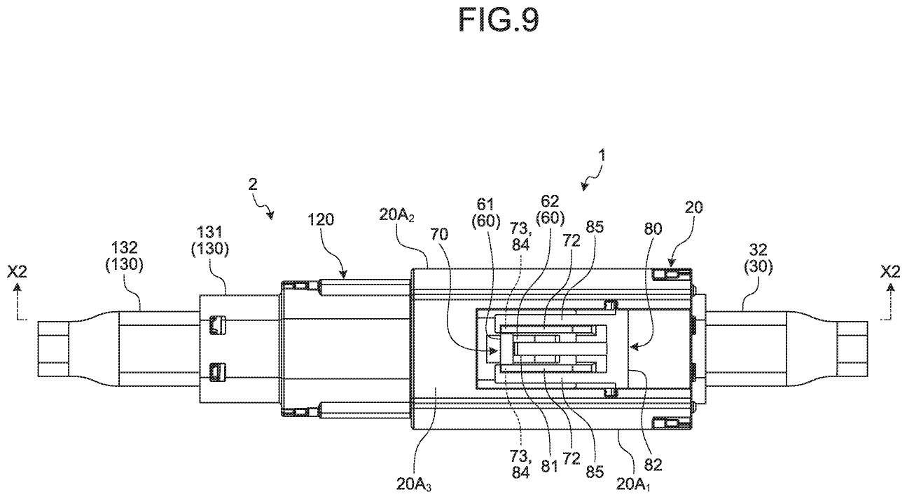

In the position regulation portion 81, the protrusion portion 81b is mounted on the second lock holding portion 62 along with elastic deformation of the arm part 81a after the first lock holding portion 61 is mounted on the second lock holding portion 62 halfway through the insertion fitting operation between the housings. In the secure member 80 of this example, the protrusion portion 81b remains mounted on the second lock holding portion 62 when the fitted state of the housings becomes the completely fitted state (FIGS. 8 and 9). The position of the secure member 80 relative to the female housing 20 is the temporary lock position when the fitted state of the housings is the completely fitted state.

The secure member 80 at the temporary lock position is moved to the side in the connector insertion direction relative to the female housing 20 when the operation portion 82 is pressed and moved to the side in the connector insertion direction. To achieve this, the secure member 80 includes a guided portion 83 that is guided when the secure member 80 is moved relative to the female housing 20 (FIGS. 3, 5, and 8). In addition, the outer housing 20A of the female housing 20 includes a guiding portion 28 that guides the guided portion 83 when the secure member 80 is relatively moved (FIGS. 3, 5, and 8). In the secure member 80 of this example, rectangular pieces protrude from both ends of the operation portion 82 in the first orthogonal direction, and each piece is used as the guided portion 83. Each guided portion 83 is formed so that the plate thickness direction thereof is aligned with the second orthogonal direction. The guiding portion 28 is a groove portion extending in the connector insertion-removal direction and is provided for guided portion 83.

The guiding portion 28 guides the guided portion 83 in the connector insertion-removal direction while the plate of each guided portion 83 is locked by two wall surfaces 28a and 28b (FIG. 3) oppositely disposed at an interval form each other in the second orthogonal direction.

The protrusion portion 81b at the temporary lock position being mounted on the second lock holding portion 62 moves over the first lock holding portion 61 through relative movement of the secure member 80 guided by the guided portion 83 and the guiding portion 28, and is disposed on the side in the connector insertion direction relative to the first lock holding portion 61 along with cancellation of the elastic deformation of the arm part 81a (FIGS. 1 and 3). Accordingly, the position of the secure member 80 relative to the female housing 20 becomes the final lock position. Thus, the secure member 80 can lock, through the position regulation portion 81, motion of the first lock holding portion 61 relative to the second lock holding portion 62 in the separation direction.

In the secure member 80, when the locked state by the position regulation portion 81 is to be canceled, the position regulation portion 81 is lifted up and separated from the first lock holding portion 61 and the second lock holding portion 62 in the second orthogonal direction and pressed and moved in the connector removal direction until the protrusion portion 81b is mounted on at least the first lock holding portion 61. Accordingly, in the holding structure 60, the first lock holding portion 61 can be lifted up and separated from the second lock holding portion 62 in the second orthogonal direction. In the fitting connector, the secure member 80 has the function of lifting up the first lock holding portion 61 (which is the function of canceling the lockable state or the locked state of the first lock holding portion 61 and the second lock holding portion 62). The function will be described below. For example, a jig may be used to lift up the position regulation portion 81.

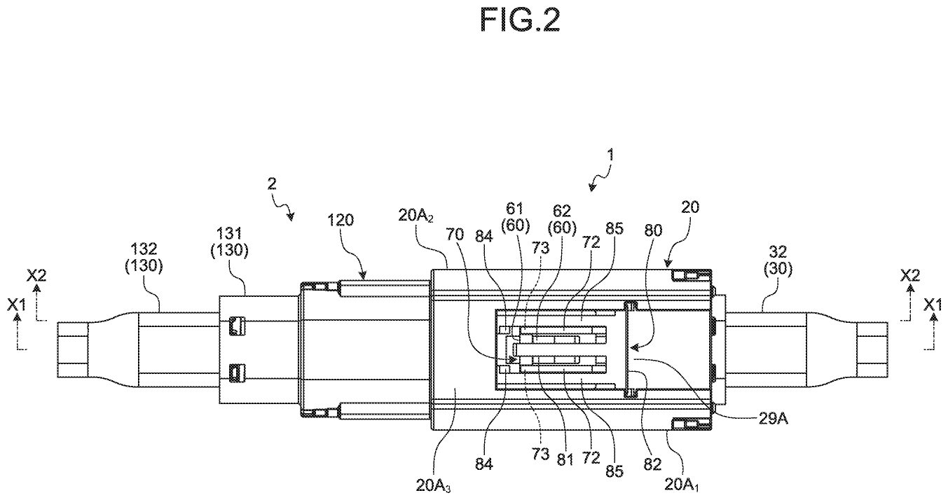

The lock holding body 70 includes a pressed movement portion 73 configured to receive cancel force in the separation direction and move the first lock holding portion 61 relative to the second lock holding portion 62 in the separation direction when the first lock holding portion 61 is to be separated from the second lock holding portion 62 (FIGS. 2 and 3). When receiving the cancel force in the separation direction, the pressed movement portion 73 elastically deforms the lock arm portion 72, thereby lifting up the first lock holding portion 61 from the second lock holding portion 62 in the separation direction. The pressed movement portion 73 is provided to each lock arm portion 72. The pressed movement portion 73 of this example uses a wall part of the lock arm portion 72 on a side opposite to the separation direction (which is a wall part of the lock arm portion 72 opposite to the outer wall surface of the terminal housing portion 121 through the through-hole 27). In this example, the pressed movement portion 73 is provided to the free end of the lock arm portion 72.

The secure member 80 includes an operation portion configured to receive lock cancel operation when the cancel force in the separation direction is to be applied on the pressed movement portion 73 (in other words, when the lockable state or the locked state of the first lock holding portion 61 and the second lock holding portion 62 is to be canceled). In this example, the operation portion 82 is used as the operation portion, having an operation function to move the secure member 80 relative to the female housing 20 in the connector insertion-removal direction. The operation portion 82 of this example is pressed and moved toward the sub outer wall surface 20Ab being oppositely disposed when the cancel force in the separation direction is to be applied on the pressed movement portion 73.

The secure member 80 includes a pressing movement portion 84 configured to apply the cancel force in the separation direction on the pressed movement portion 73 to separate the first lock holding portion 61 from the second lock holding portion 62 along with the lock cancel operation on the operation portion 82 (FIGS. 2, 3, and 5). The pressing movement portion 84 applies the cancel force in the separation direction on the pressed movement portion 73 along with the lock cancel operation on the operation portion 82 to press and move the pressed movement portion 73 in the separation direction, thereby separating the first lock holding portion 61 from the second lock holding portion 62. Thus, the pressing movement portion 84 is formed so that the pressing movement portion 84 is disposed between the pressed movement portion 73 and the outer wall surface of the terminal housing portion 121 when applying the cancel force in the separation direction on the pressed movement portion 73. The pressing movement portion 84 is provided for each pressed movement portion 73. The pressing movement portion 84 of this example is formed in a rectangular flat plate shape. The pressing movement portion 84 is formed so that the plate thickness direction thereof is aligned with the second orthogonal direction.

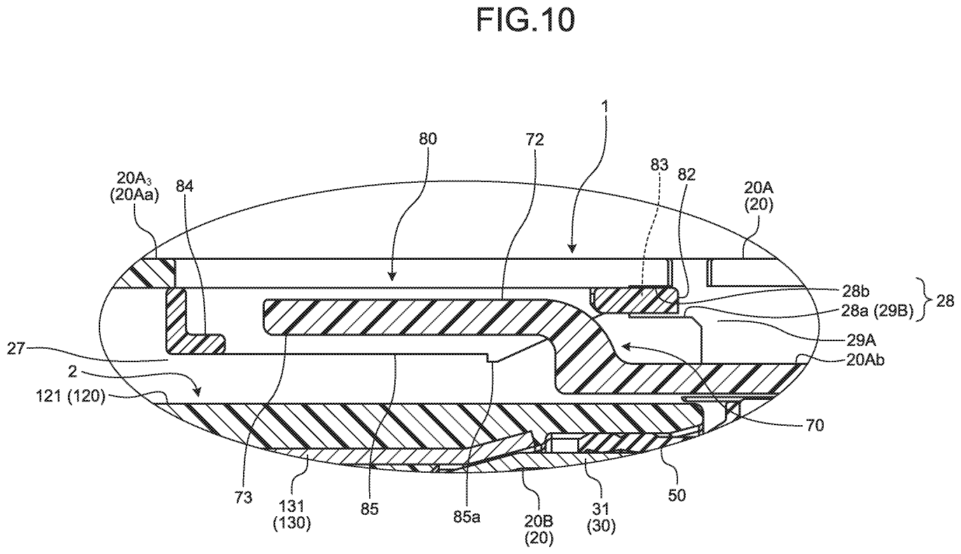

The secure member 80 includes a lock cancel arm portion 85 connecting the operation portion 82 and the pressing movement portion 84 so that motion of the pressing movement portion 84 in the separation direction occurs along with the lock cancel operation on the operation portion 82 (FIGS. 1 to 5). The lock cancel arm portion 85 is provided for each pressing movement portion 84. The lock cancel arm portion 85 is an arm part that is a non elastically deformable cantilever extending in the connector insertion-removal direction, and has a fixed end on the operation portion 82 side and a free end provided with the pressing movement portion 84. The lock cancel arm portion 85 is formed so that the lock arm portion 72 is disposed between the lock cancel arm portion 85 and the position regulation portion 81 in the first orthogonal direction when the secure member 80 is assembled to the female housing 20. Thus, the pressing movement portion 84 is provided while protruding toward the position regulation portion 81 at the free end of the lock cancel arm portion 85 so that the pressing movement portion 84 is disposed opposite to the pressed movement portion 73 in the second orthogonal direction. The lock cancel arm portion 85 of this example includes a pivot part 85a configured to contact the sub outer wall surface 20Ab and serve as a pivot to allow seesaw operation between the operation portion 82 and the pressing movement portion 84 of the secure member 80 (FIGS. 5 and 10). Thus, the secure member 80 can perform the seesaw operation between the operation portion 82 and the pressing movement portion 84 with the pivot part 85a as a pivot. In this example, the pivot part 85a contacts the sub outer wall surface 20Ab when the secure member 80 is at the temporary lock position.

The pressing movement portion 84 may be formed to apply the cancel force in the separation direction on the pressed movement portion 73 irrespective of the position of the secure member 80 relative to the female housing 20. However, in this case, through the lock cancel operation on the operation portion 82 when the secure member 80 is at the final lock position, the locked state of the first lock holding portion 61 and the second lock holding portion 62 by the position regulation portion 81 is potentially canceled and the lockable state or the locked state of the first lock holding portion 61 and the second lock holding portion 62 is potentially canceled.

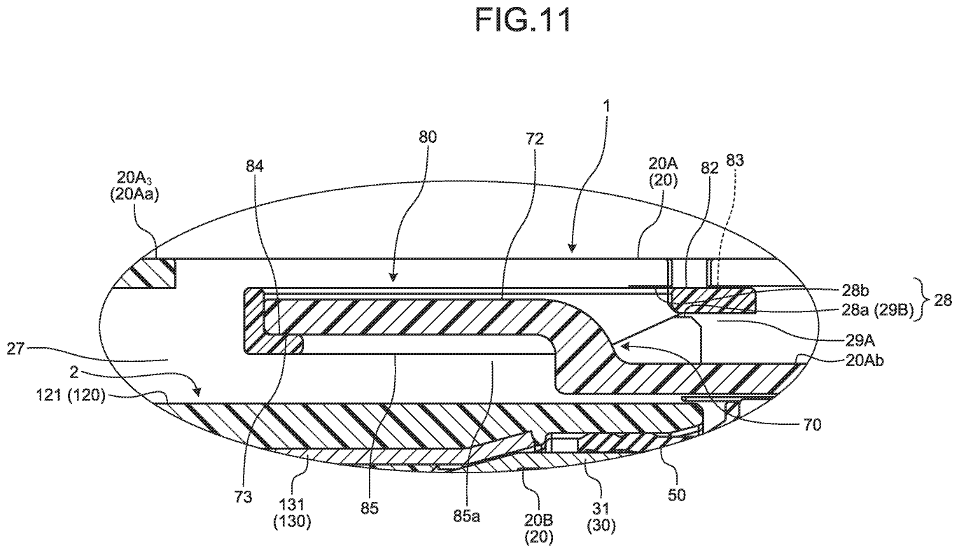

Thus, the pressing movement portion 84 is desirably formed not to apply the cancel force in the separation direction on the pressed movement portion 73 when the secure member 80 is at the final lock position (FIGS. 2 and 10), but to apply the cancel force in the separation direction on the pressed movement portion 73 when the locked state of the first lock holding portion 61 and the second lock holding portion 62 by the position regulation portion 81 of the secure member 80 is canceled (FIGS. 9 and 11). Accordingly, in the fitting connector, when the lock cancel operation is performed on the operation portion 82 of the secure member 80 at the final lock position, the lockable state or the locked state of the first lock holding portion 61 and the second lock holding portion 62 can be prevented from being canceled irrespective of cancellation of the locked state of the first lock holding portion 61 and the second lock holding portion 62 by the position regulation portion 81. In addition, in the fitting connector, the lockable state or the locked state of the first lock holding portion 61 and the second lock holding portion 62 can be canceled when the lock cancel operation is performed on the operation portion 82 of the secure member 80 after the protrusion portion 81b of the position regulation portion 81 lifted up by, for example, the jig described above is mounted on at least the first lock holding portion 61.

In this example, when the secure member 80 is at the temporary lock position after the protrusion portion 81b is mounted on the second lock holding portion 62, the pressing movement portion 84 applies the cancel force in the separation direction on the pressed movement portion 73. Thus, in this example, the pressing movement portion 84 is formed to apply the cancel force in the separation direction on the pressed movement portion 73 when the secure member 80 is at the temporary lock position.

Accordingly, the secure member 80 of this example is formed so that the pressing movement portion 84 is disposed on the side in the connector insertion direction relative to the pressed movement portion 73 at the final lock position, and the pressing movement portion 84 is disposed opposite to the pressed movement portion 73 in the second orthogonal direction at the temporary lock position. In other words, the pressing movement portion 84 is formed so that the pressed movement portion 73 is not disposed on the separation direction side relative to the pressing movement portion 84 when the secure member 80 is at the final lock position, and the pressed movement portion 73 is oppositely disposed on the separation direction side relative to the pressing movement portion 84 when the secure member 80 is at the temporary lock position. The pressing movement portion 84 is formed so that the pressing movement portion 84 at the temporary lock position can contact and lift up the pressed movement portion 73 when moved toward the separation direction side through at least the seesaw operation between the operation portion 82 and the pressing movement portion 84 with the pivot part 85a as a pivot.

In this manner, when the lock cancel operation is performed on the operation portion 82 of the secure member 80 at the final lock position, the pressing movement portion 84 potentially cancels the locked state of the first lock holding portion 61 and the second lock holding portion 62 by the position regulation portion 81. To avoid this, the outer housing 20A of the female housing 20 includes an operation allowance part 29A configured to allow, when the secure member 80 is at the temporary lock position, the lock cancel operation on the operation portion 82 so that the pressing movement portion 84 applies the cancel force in the separation direction on the pressed movement portion 73 (FIGS. 1, 3, 5, 10, and 11). In addition, the outer housing 20A includes an operation regulation part 29B configured to regulate, when the secure member 80 is at the final lock position, the lock cancel operation on the operation portion 82 so that the pressing movement portion 84 does not apply the cancel force in the separation direction on the pressed movement portion 73 (FIGS. 3, 10, and 11).

The operation allowance part 29A is a space part into which the operation portion 82 and the two guided portions 83 configured to operate along with motion of the operation portion 82 can be moved when the operation portion 82 of the secure member 80 at the temporary lock position receives the lock cancel operation. The operation allowance part 29A of this example is a space part in which seesaw operation of the secure member 80 with a contact point between the guided portion 83 and the operation regulation part 29B (the wall surface 28a) described below as a pivot can be performed when the operation portion 82 of the secure member 80 at the temporary lock position receives the lock cancel operation. In this example, a space part provided between the sub outer wall surface 20Ab and each of the operation portion 82 and the two guided portions 83 on the side in the connector removal direction relative to the operation regulation part 29B (the wall surface 28a) is used as the operation allowance part 29A.

Accordingly, when the operation portion 82 receives the lock cancel operation, the secure member 80 at the temporary lock position can perform seesaw operation with the contact point between the guided portion 83 and the operation regulation part 29B (the wall surface 28a) as a pivot while the operation portion 82 and the two guided portions 83 are moved toward the sub outer wall surface 20Ab in the operation allowance part 29A. Thus, in the fitting connector, the pressing movement portion 84 can apply the cancel force in the separation direction on the pressed movement portion 73 when the operation portion 82 receives the lock cancel operation at the temporary lock position, and thus can cancel the lockable state or the locked state of the first lock holding portion 61 and the second lock holding portion 62.

The operation regulation part 29B is a wall part that locks, when the operation portion 82 of the secure member 80 at the final lock position receives the lock cancel operation, motion of each guided portion 83 configured to operate along with motion of the operation portion 82. The operation regulation part 29B is provided for each guided portion 83. In this example, a wall surface of the guiding portion 28 opposite to the guided portion 83 is used as the operation regulation part 29B. In this example, the wall surface 28a of the guiding portion 28 on the side opposite to the separation direction is used as the operation regulation part 29B. Thus, in the secure member 80 at the final lock position, the two guided portions 83 are locked by the respective operation regulation parts 29B when the operation portion 82 receives the lock cancel operation.

Thus, when the operation portion 82 receives the lock cancel operation at the final lock position, the fitting connector can prevent application of the cancel force in the separation direction on the pressed movement portion 73 by the pressing movement portion 84, and can prevent pressed movement of the pressed movement portion 73 by the pressing movement portion 84 if the cancel force in the separation direction is applied on the pressed movement portion 73 by the pressing movement portion 84.

Accordingly, when the operation portion 82 receives the lock cancel operation at the final lock position, the fitting connector can prevent cancellation of the locked state of the first lock holding portion 61 and the second lock holding portion 62 by the position regulation portion 81, and can prevent cancellation of the lockable state or the locked state of the first lock holding portion 61 and the second lock holding portion 62.

The secure member 80 is formed so that the secure member 80 can be moved from the temporary lock position to the final lock position relative to the female housing 20 when the fitted state of the housings is the completely fitted state, and is assembled to the female housing 20. Thus, the secure member 80 may be formed so that the secure member 80 cannot be moved from the temporary lock position to the final lock position relative to the female housing 20 when the fitted state of the housings is the halfway fitted state, and may be assembled to the female housing 20 so that the secure member 80 can be used to sense the fitted state of the housings. For example, when the secure member 80 can be relatively moved from the temporary lock position to the final lock position, a worker or the like can determine that the fitted state of the housings (connectors) is the completely fitted state. When the secure member 80 cannot be relatively moved from the temporary lock position to the final lock position, the worker or the like can determine that the fitted state of the housings (connectors) is the halfway fitted state.

As described above, since the secure member 80 has the function of canceling lock by the holding structure 60, the fitting connector according to the present embodiment can have a reduced size as compared to a conventional fitting connector in which the holding structure has the lock cancel function. For example, in the conventional fitting connector, the lock cancel arm portion is disposed side by side with the lock arm portion of the holding structure in the second orthogonal direction, and the arm part of the secure member is provided outside of the lock cancel arm portion in the second orthogonal direction. However, in the fitting connector according to the present embodiment, the lock cancel arm portion and the arm part of the secure member in the conventional holding structure are integrated, and the lock cancel arm portion 85 of the secure member 80 is disposed side by side with the lock arm portion 72 of the holding structure 60 in the second orthogonal direction. Thus, the fitting connector according to the present embodiment can have a reduced size in the second orthogonal direction as compared to the conventional fitting connector.

In addition, in the fitting connector according to the present embodiment, the formability of the female housing 20 (outer housing 20A) can be increased since the lock cancel arm portion 85 is provided to the secure member 80. For example, in the conventional fitting connector, the lock arm portion and the lock cancel arm portion are formed integrally with the housing, which potentially leads to a complicated mold. However, in the fitting connector according to the present embodiment, the lock cancel arm portion 85 is provided to the secure member 80 as a member separated from the female housing 20 (outer housing 20A), and thus a mold of the female housing 20 (outer housing 20A) can be simpler than that conventionally used, which increases the formability of the female housing 20 (outer housing 20A).

In addition, in the fitting connector according to the present embodiment, insertion force for fitting the first connector 1 and the second connector 2 to each other by insertion can be reduced since the lock cancel arm portion 85 is provided to the secure member 80. For example, in the conventional fitting connector, since the lock arm portion and the lock cancel arm portion are provided to the housing, reaction force of force applied on the lock arm portion and reaction force of force applied on the lock cancel arm portion are added to the insertion force when the first connector and the second connector are fitted to each other by insertion. However, in the fitting connector according to the present embodiment, since the lock cancel arm portion 85 is provided to the secure member 80 as a member separated from the female housing 20 (outer housing 20A), no reaction force from the lock cancel arm portion 85 is applied in response to the insertion force for fitting the first connector 1 and the second connector 2 to each other by insertion. Thus, in the fitting connector according to the present embodiment, the insertion force for fitting the first connector 1 and the second connector 2 to each other by insertion is reduced as compared to that conventionally applied.

In the above-described example, when the fitted state of the housings is the completely fitted state, the protrusion portion 81b is mounted on the second lock holding portion 62 at the temporary lock position of the secure member 80. However, in the fitting connector of this example, as described above, when the fitted state of the housings becomes the completely fitted state, the male housing 120 is pressed back by snapping force of each elastic member 25 in the extension direction through the inner housing 20B, and the first lock holding portion 61 and the second lock holding portion 62 are locked to each other. Thus, in the fitting connector, a gap G is generated between the first lock holding portion 61 and the second lock holding portion 62 before the pressing back.

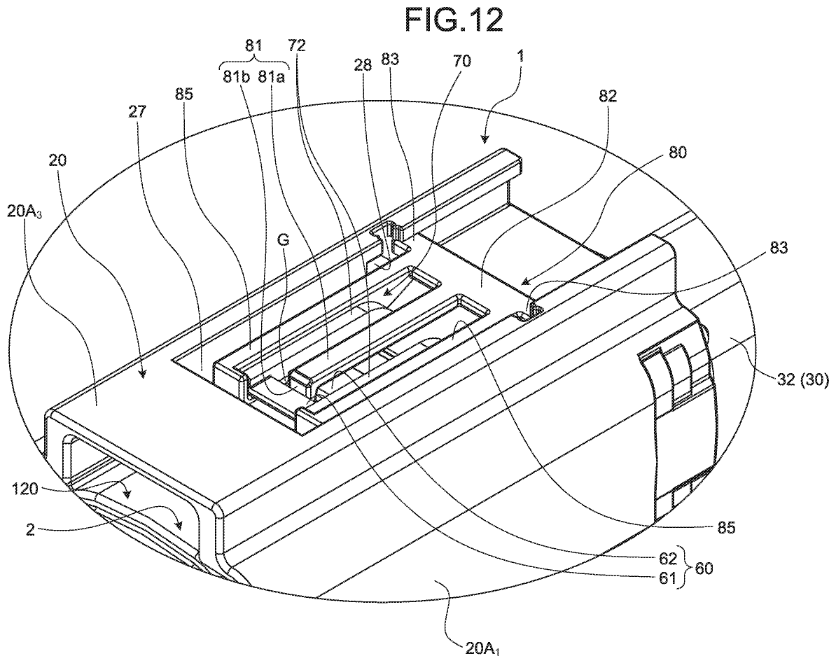

Therefore, if the gap G has a size large enough for the protrusion portion 81b of the secure member 80 to enter, the temporary lock position of the secure member 80 may be a state in which the protrusion portion 81b is in the gap G (FIG. 12). In a fitting connector according to the present embodiment, since a secure member has the function of canceling lock by a holding structure, a size reduction can be achieved as compared to that of the conventional fitting connector in which the holding structure has the lock cancel function. For example, in the conventional fitting connector, a lock cancel arm portion is disposed side by side with a lock arm portion of the holding structure, and an arm part of the secure member is provided outside of the lock cancel arm portion in the disposition direction.

However, in the fitting connector according to the present embodiment, the lock cancel arm portion and the arm part of the secure member in the conventional holding structure are integrated, and the lock cancel arm portion of the secure member is disposed side by side with the lock arm portion of the holding structure. Thus, the fitting connector according to the present embodiment can have a reduced size in the disposition direction of the lock arm portion and the lock cancel arm portion as compared to the conventional fitting connector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fitting connector comprising:
a first connector that includes a terminal and a housing holding the terminal;
a second connector that includes a counterpart terminal and a counterpart housing holding the counterpart terminal and is configured to electrically connect the terminal and the counterpart terminal when a fitted state of the housing and the counterpart housing upon insertion fitting is a completely fitted state;
a holding structure that includes a first lock holding portion provided to the housing and a second lock holding portion provided to the counterpart housing and is configured to cause the first lock holding portion and the second lock holding portion to be in a lockable state in a connector removal direction to hold the fitted state as the completely fitted state when the fitted state is the completely fitted state; and
a secure member configured to secure, when the fitted state is the completely fitted state, that the fitted state is the completely fitted state by regulating motion of the first lock holding portion relative to the second lock holding portion in a separation direction, wherein
the housing includes a lock holding body including the first lock holding portion and a pressed movement portion configured to move the first lock holding portion relative to the second lock holding portion in the separation direction while receiving cancel force in the separation direction, and
the secure member includes a position regulation portion configured to regulate motion of the first lock holding portion relative to the second lock holding portion in the separation direction when the fitted state is the completely fitted state, an operation portion configured to receive lock cancel operation when the lockable state of the first lock holding portion and the second lock holding portion is to be canceled, and a pressing movement portion configured to apply the cancel force in the separation direction on the pressed movement portion to separate the first lock holding portion from the second lock holding portion along with the lock cancel operation on the operation portion.

2. The fitting connector according to claim 1, wherein
the secure member is assembled to the housing so that, when the fitted state is the completely fitted state, the secure member is relatively movable between a final lock position at which the position regulation portion regulates motion of the first lock holding portion relative to the second lock holding portion in the separation direction and a temporary lock position at which the position regulation portion does not regulate motion of the first lock holding portion relative to the second lock holding portion in the separation direction, and
the pressing movement portion is formed not to apply the cancel force in the separation direction on the pressed movement portion when the secure member is at the final lock position but to apply the cancel force in the separation direction on the pressed movement portion when the secure member is at the temporary lock position.

3. The fitting connector according to claim 2, wherein
the pressing movement portion is formed so that the pressed movement portion is not disposed on a side in the separation direction relative to the pressing movement portion when the secure member is at the final lock position, but the pressed movement portion is oppositely disposed on the side in the separation direction relative to the pressing movement portion when the secure member is at the temporary lock position.

4. The fitting connector according to claim 2, wherein
the housing includes an operation allowance part configured to allow, when the secure member is at the temporary lock position, the lock cancel operation on the operation portion so that the pressing movement portion applies the cancel force in the separation direction on the pressed movement portion, and an operation regulation part configured to regulate, when the secure member is at the final lock position, the lock cancel operation on the operation portion so that the pressing movement portion does not apply the cancel force in the separation direction on the pressed movement portion.

5. The fitting connector according to claim 3, wherein
the housing includes an operation allowance part configured to allow, when the secure member is at the temporary lock position, the lock cancel operation on the operation portion so that the pressing movement portion applies the cancel force in the separation direction on the pressed movement portion, and an operation regulation part configured to regulate, when the secure member is at the final lock position, the lock cancel operation on the operation portion so that the pressing movement portion does not apply the cancel force in the separation direction on the pressed movement portion.

6. The fitting connector according to claim 4, wherein
the secure member includes a guided portion that is guided when the secure member is moved relative to the housing, and
the housing includes a guiding portion that guides the guided portion when the secure member is relatively moved, and a wall surface of the guiding portion opposite to the guided portion is used as the operation regulation part.

7. The fitting connector according to claim 1, wherein
the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

8. The fitting connector according to claim 2, wherein
the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

9. The fitting connector according to claim 3, wherein
the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

10. The fitting connector according to claim 4, wherein
the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

11. The fitting connector according to claim 6, wherein
the lock holding body includes a lock arm portion that is an elastically deformable cantilever provided with the first lock holding portion at a free end and provided with a fixed end on a side in the connector removal direction relative to the first lock holding portion, and the lock arm portion is provided with the pressed movement portion.

12. The fitting connector according to claim 7, wherein
the lock holding body uses, as the pressed movement portion, a wall part of the lock arm portion on a side opposite to the separation direction.

13. The fitting connector according to claim 1, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

14. The fitting connector according to claim 2, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

15. The fitting connector according to claim 3, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

16. The fitting connector according to claim 4, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

17. The fitting connector according to claim 6, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

18. The fitting connector according to claim 7, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.

19. The fitting connector according to claim 12, wherein
the secure member includes a lock cancel arm portion connecting the operation portion and the pressing movement portion so that motion of the pressing movement portion in the separation direction occurs along with the lock cancel operation on the operation portion, and
the lock cancel arm portion includes a pivot part configured to contact an outer wall surface of the housing and serve as a pivot to allow seesaw operation between the operation portion and the pressing movement portion of the secure member.
